(19) United States
(12) Patent Application Publication
(10) Pub. No.: US 2018/0178403 A1
(43) Pub. Date: Jun. 28, 2018

(54) Automatic Enclosed Food Slicer

(71) Applicant: Frank Vivirito, Bloomingron, IL (US)

(72) Inventor: Frank Vivirito, Bloomingron, IL (US)

(21) Appl. No.: 15/390,098

(22) Filed: Dec. 23, 2016

(51) Int. Cl. B26D 7/22; B26D 7/01; B26D 5/08; B26D 5/00; B26D 7/32; B26D 1/00

(52) U.S. Cl. CPC B26D 7/225; B26D 7/01; B26D 5/086; B26D 2001/006; B26D 7/32; B26D 1/0006; B26D 2210/02; B26D 5/005

(57) ABSTRACT

An automatic enclosed food slicing apparatus including a housing defining a slicing compartment and a food compartment and including a cover. The cover has an open position allowing access to the food compartment and a closed position preventing access to the food compartment. A feed bed is located within the food compartment for placing food to be sliced, and a gripper moves the food along the feed bed and into the slicing compartment. A blade slices the food as it moves into the slicing compartment. A motor is drivingly connected to the blade to rotate the blade and drivingly connected to the gripper to move the gripper along the feed bed. A controller controls the speed at which the blade rotates, and the speed at which the gripper moves along the feed bed. A conveyor located within the slicing compartment and extending out from the slicing compartment accepts the sliced food product and through communication with the electronic controls arranges the sliced product into desirable “layout” configurations.

### PRIORITY

This application claims priority and benefits by reference in its entirety, U.S. Non-Provisional patent application Ser. No. 15/192,548, entitled “Automatic Enclosed Food Slicer”, and filed Jun. 24, 2016.

### BACKGROUND OF THE INVENTION

### Technical Field

The present invention generally relates to food preparation equipment and particularly to devices for slicing food. These devices commonly referred to as deli slicing machines.

### Background Art

The slicing of food product such as processed meats and cheeses in restaurants, grocery stores and many retail and wholesale locations is generally performed on a machine commonly known as a “Deli Slicer”. The development of the first modern deli-slicing machine occurred in the 1800's. A carriage of food product was pushed parallel to an exposed circular rotating slicing knife.

This design and subsequent improvements such as a reciprocating arm was and still is designed to operate at roughly the speed of one slice per second. These slicing machines are labor intensive to operate and are slow to slice food product. An individual is typically required to operate existing deli slicing machines. Very little consideration is given to any “layout” or treatment of the product once the product has been sliced.

These machines are unsafe in their design and operation due to the exposed rotating circular knife. The design of existing machines cause the knife to become more exposed as the slice thickness increases.

An additional safety concerns is that manually operated machines require a person to grasp a handle and repeatedly push a large carriage containing the food product past the rotating knife, then quickly pull the carriage back to an original position. This repetitive motion contributes to the physical disability commonly referred to as Carpel tunnel or Repetitive stress Injury. The proposed machine eliminates this repetitive motion.

In regard to the industry of producing pre-sliced food product for retail sale in grocery or convenience stores and pre sliced food product boxed and sold to restaurants. This pre-packaged pre-sliced food product industry, which has annual sales in the hundred of millions of dollars, is generally controlled by only the largest food processing manufacturers. Think Hormel and Kraft. Today in order to economically produce these pre-sliced packages expensive high volume machines are required to quickly slice, layout and display sliced product while maintaining exact slice thickness and slice count per package. These packages are then sold to local grocery stores and restaurants at a large cost premium over the cost of food product which can be purchased in bulk.

### SUMMARY

An automatic enclosed food slicer including a housing defining a slicing compartment and a food compartment and including a cover is disclosed. The cover has an open position allowing access to the food compartment and a closed position preventing access to the food compartment. A feed bed is located within the food compartment for placing food to be sliced, and a gripper moves the food along the feed bed and into the slicing compartment. A blade slices the food as it moves into the slicing compartment. A motor is drivingly connected to the blade to rotate the blade, and a second motor is drivingly connected to the gripper to move the gripper along the feed bed. An electronic controller controls the speed at which the blade rotates, and a second electronic controller controls the speed at which the gripper moves the product along the feed bed.

A conveyor located within the slicing compartment and extending out from the slicing compartment accepts the sliced food product and through communication with the electronic controls arranges the sliced product into desirable “layout” configurations.

### BRIEF DESCRIPTION OF THE DRAWINGS

FIG. 1 is a perspective view of the front and side elevations of a slicing machine according to an exemplary embodiment of the invention. The machine view shows a front take away conveyor, and both the stainless steel and clear plastic safety covers.

FIG. 2 is a view of the front of the slicing machine control panel according to an exemplary embodiment of the invention.

FIG. 3 is a perspective view of the rear and backside of a slicing machine according to an exemplary embodiment of the invention. The view shows an exemplary full enclosure of mechanical and slicing areas.

FIG. 4 is a perspective view of a slicing machine with a front cutaway view showing detail of at least some of the individual main components of the slicing machine, according to an exemplary embodiment of the invention.

FIG. 5 is a perspective view of a slicing machine with a rear cutaway view showing at least of the individual components, of the apparatus to advance the food product.

FIG. 6 is a comparison of the front and side view of a circular knife that is used in existing slicing machines of the prior art and a front and side view of an involute knife for the slicing according to an exemplary embodiment of the invention.

FIG. 7 is a perspective front and side drawing of a slicing machine, showing at least some of the structural internals according to an exemplary embodiment of the invention.

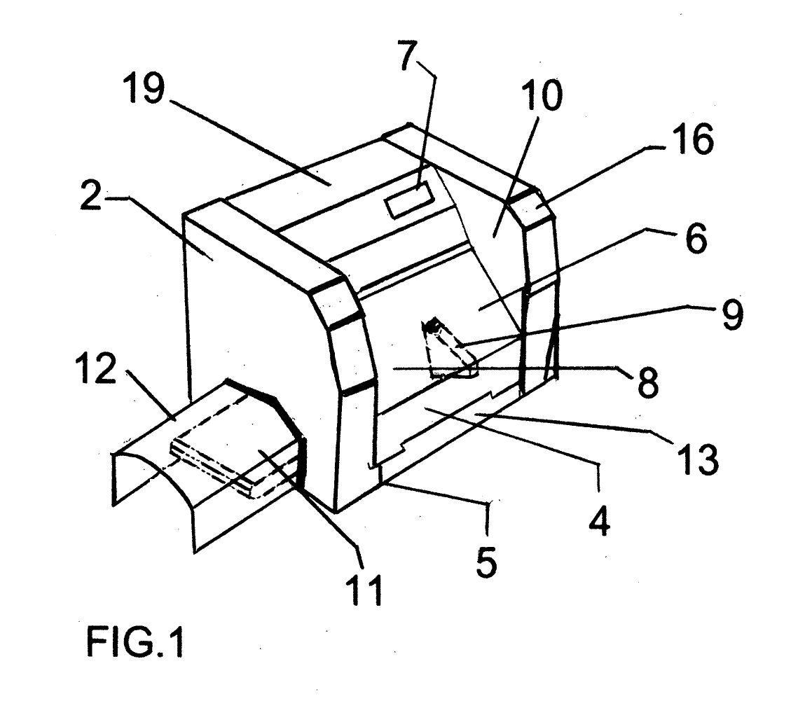

FIG. 1 Front operator side and front take away view of improved slicing machine

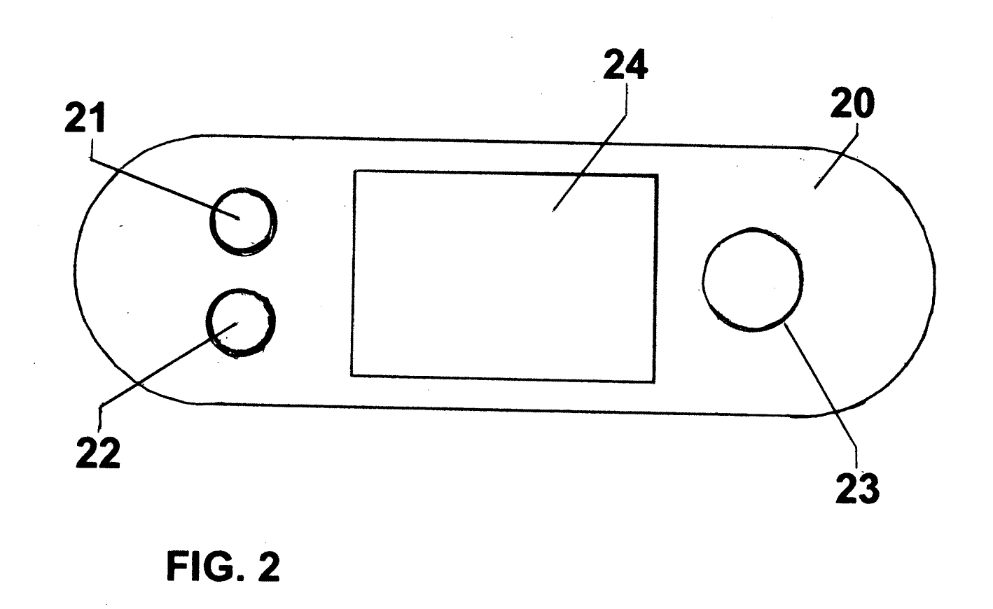

FIG. 2 Control Panel

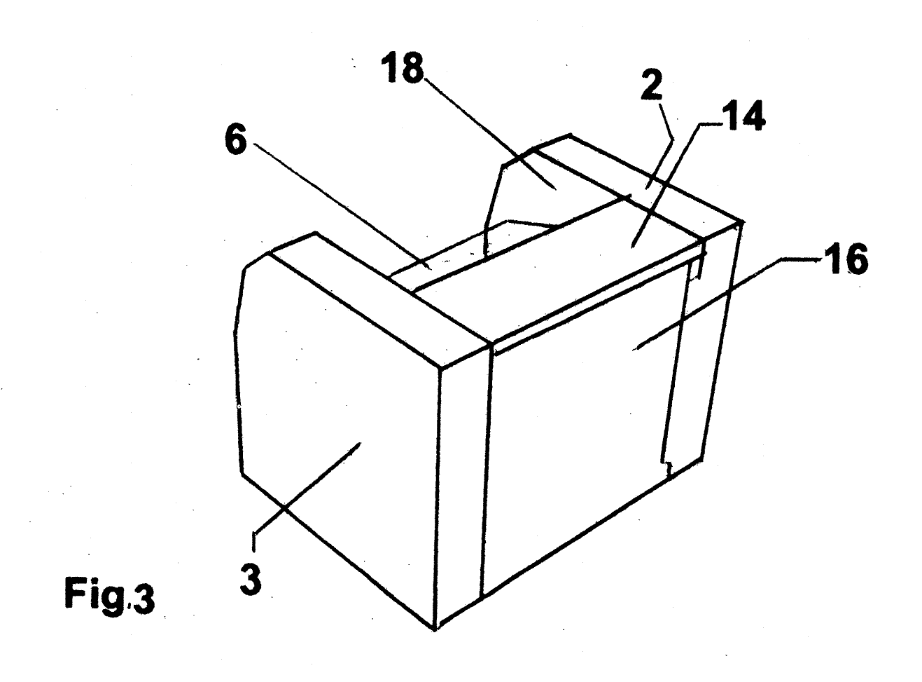

FIG. 3 Back view and rear view of improved slicing machine

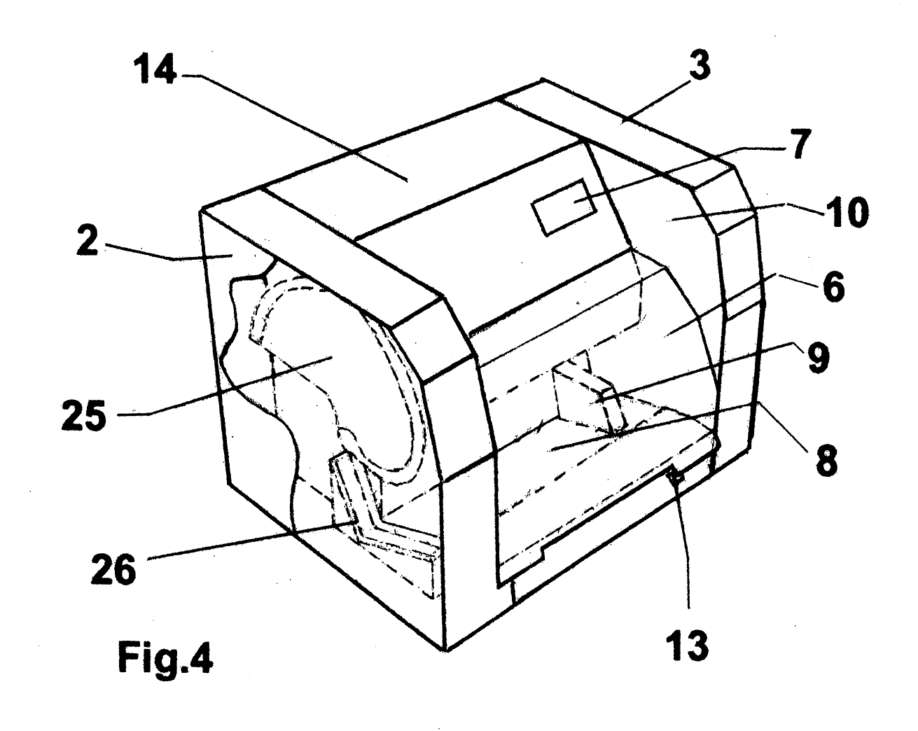

FIG. 4 Front cut-away view of improved slicing machine

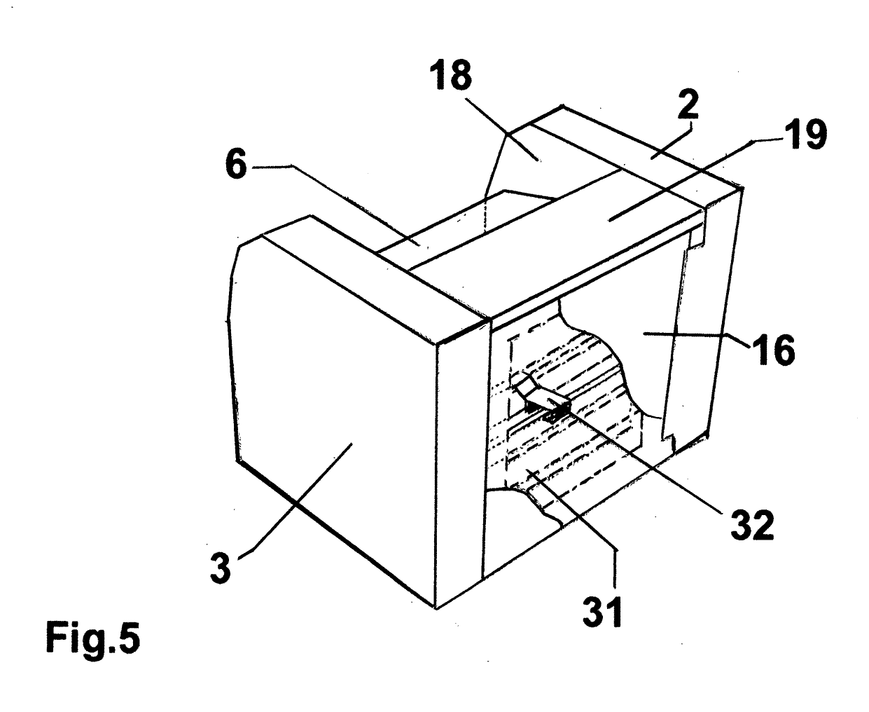

FIG. 5 Cut away view of rear of slicing machine showing internal drive mechanism

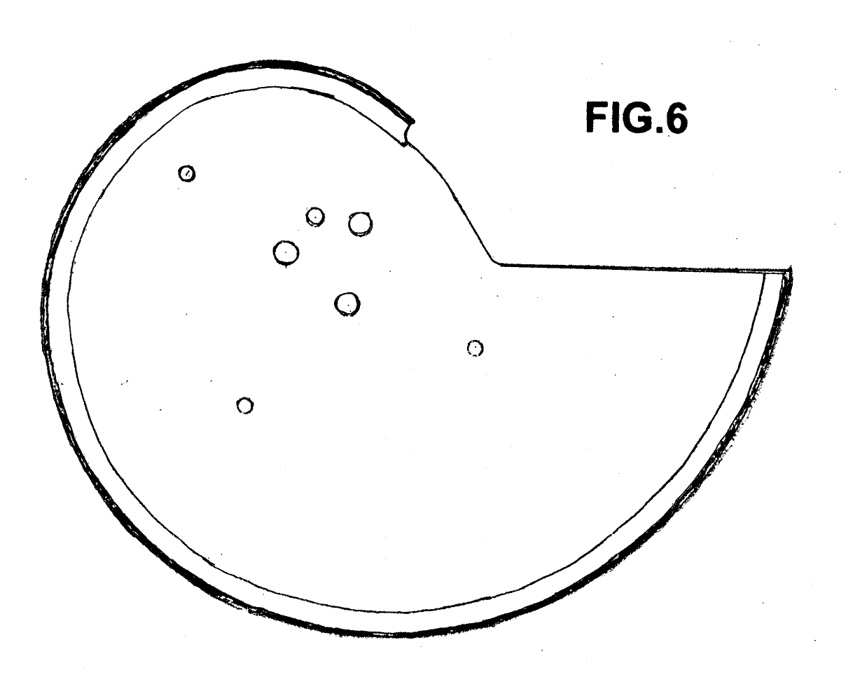

FIG. 6 Involute Knife

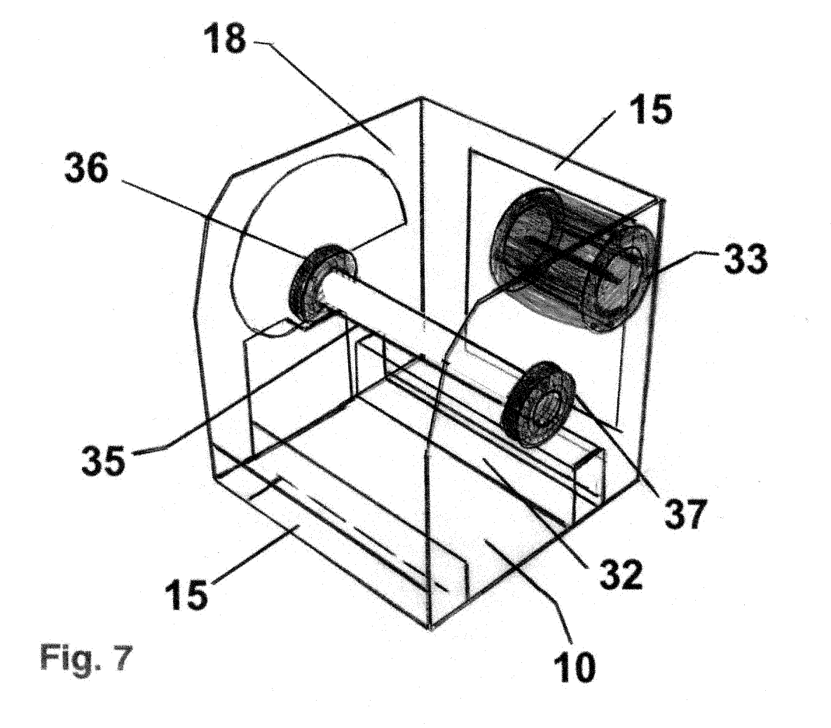

FIG. 7 Mechanical detail of the feed drive system

### DETAILED DESCRIPTION OF THE INVENTION

An existing slicing machine for the slicing of blocks or loaves of food product such as meats, meat product, and cheese usually feeds the loaves of product forward and past a circular rotating knife. These machines slice blocks of product into relatively thin consistent slices. The slicing operation typically involves the placing of a food loaf on a flat, slanted or horizontal carriage with the face of the product perpendicular to the circular rotating knife. The loaf is usually held in place by a gripping device typically located at the back or top of the loaf and designed to stabilize the position of the food loaf on the carriage as well as to provide pressure on the loaf and pushing the loaf toward the knife.

The operator of existing slicing machines typically loads the product onto the carriage then turns a rotating selecting knob designed to adjust the slicing thickness. This selector knob is mechanically attached to either the knife, carriage or some slicing plane adjusting mechanism. The adjusting of slice thickness in this manner typically exposes the cutting edge of the rotating knife to the desired thickness of a slice. This portion of the knife-cutting surface is exposed to the machine operator for the entire time that slicing occurs. Indeed even when the machine is not slicing, the exposed knife unless purposefully returned to the zero slice thickness position will remain dangerously exposed to any passing individual.

The food loaf, after slice thickness has been chosen, is then pushed past the rotating circular knife thus producing one slice of food product. The carriage is then pulled back to the original position forward of the circular knife. The machine is now ready for the next slice.

The sliced product which typically falls onto some accepting tray is either allowed to fall at random or the machine operator may grab each slice by hand and stack the slice or “layout” the slice into some overlapping configuration.

Existing slicing machines operate in one of two manners, referred to as; manually or automatically. In the case of the manually operated slicing machine a person will grasp a handle attached to the food loaf carriage and while applying pressure on the loaf thru a gripping handle passes the loaf past the rotating circular knife. One pass forward and one pass back is required for each slice. The amount of force applied to the loaf through the gripper influences the resulting slice thickness. Thus a uniformity of thickness of all slices may be difficult to obtain. This repetitive motion required for each and every slice occurs only through the force and action applied by the machine operator and may cause repetitive stress injury.

In the case of existing automatic slicing machines the food loaf is loaded onto a similar carriage with the front loaf face toward the circular knife. A gripping device is then located at the rear or top of the loaf to secure the loaf and to apply pressure onto the loaf. The carriage and gripper are attached to some type of mechanical drive unit that automatically pushes the food carriage forward past the rotating circular knife and then back to the original position. The mechanical drive unit then automatically moves forward and back producing another slice. This slicing reciprocating cycle is done at the approximate speed of a slice per second.

Existing slicing machines because of their open carriage and exposed knife design require some operator or amount of labor at every moment the machine is in operation. The manual machine requires an amount of labor for every moment the machine is operating. Indeed, slicing and stacking of product only occur through the physical motion of an operator. The “automatic” machines require labor to monitor the machine at every moment because of the exposed knife design and because of the reciprocating metal carriage which can injure workers who pass by or interfere with the slicing machines operation.

The original patents for this design of slicing machine date to the 1890's, and describe a “flywheel” type powered machine. Subsequent improvements have included attaching electric motors, modifying the machine for easier cleaning including detachable parts, adding safety guarding, rudimentary stacking and layout devices and conveyor belts. However, the basic design which is generally a loaf of food product moving past a rotating circular knife has essentially remained the same since the 1890's.

The proposed slicing machine is a radical redesign of this ancient machine addressing the issues described above including: 1) safety, whether it be the danger of injury through cutting of hands and limbs by the knife or the injury resulting from repetitive stress; 2) problem of consistent slice thickness; 3) the problem of laying out of sliced product into desirable “drafts” which can be easily handled and or packaged after the slicing operation; or 4) the problem of excessive labor required to operate these machines.

The new apparatus provides a new and improved high speed food loaf slicing and layout machine, utilizing an involute rotating knife; which also allows for a mechanical positioning drive unit and associated electronic controller to push the food product through the plane of a rotating involute knife creating a slice, not across the face of a circular knife as with existing machines.

The proposed machine eliminates the dangers of injury from the slicing operation. The entire slicing operation is accomplished within a fully enclosed “box”. This “box” or working area includes a rotating knife 25; which is completely enclosed within a stainless steel knife guard door 2 slicing chamber with no possibility of exposure to workers. The “box” includes a feed bed 8; on which the food loaf is placed. Access to the feed bed is restricted to when the machine is in the off position. For the loaf to be loaded into the feed bed, a clear plastic (or other material) shield needs to be raised. Once the loaf is loaded on the feedbed, the shield 6 is lowered and locked by pneumatic or some other means, so as to prevent the door from opening until the slicing is complete. The moving food carriage which is present on existing machines is eliminated in the new design, further removing the possibility of injury due to moving parts. Indeed, no moving parts are exposed during the slicing operation.

The proposed machine provides a highly accurate, consistent, and/or uniform slice thickness. A positioning device and associated electronic controller 24; capable of movements of one thousandths ( 1/1000s) of an inch controls the advance of the food product through the rotating knife, and eliminates the inconsistencies of slice thickness associated with existing mechanical or operator controlled designs.

The proposed machine increases the rate of speed at which a food product may be sliced. As different types of food product may need to be sliced at different rates of speed, the controls of the proposed machine, whether the controls may be electrical, electronic, or of another type, may allow an operator to select a type of product to be sliced i.e. meats, cheese, and the controls adjust slicing speeds in order to maximize the rates at which product can be sliced. To adjust the slicing speeds, the controls adjust the speed with which the product is pushed forward. The proposed machine results in speed increases of 4 to 25 times the rate of existing slicing machines. One slice per second on existing machines can become 25 slices per second on this new machine.

The proposed slicing machine is designed to be easily cleaned. The mechanical drive parts are enclosed within two different mechanical housing areas. All the drives motors, sheaves, electrical parts and sub-parts are contained within these mechanical areas. All areas are shielded behind food grade stainless steel or food grade acetal plastic. The food contact area is separate and distinct from the mechanical areas. The food contact area has parts, such as the feed bed 8, food gripper 9 and shear edge 26, which are easily removed without the need for tools. These removable food contact parts are then available for easy thorough cleaning.

The proposed slicing machine allows an operator to slice food product, and layout the product at very high rates of speed. The proposed slicing machine, by eliminating the cost of labor, allows the economical slicing and packaging of pre-sliced product in retail locations. This eliminates the near monopoly that the large factory food processing companies have in the slicing and packaging of pre sliced meat and cheese product for retail sale.

Referring now to FIG. 1 an exemplary slicing machine is illustrated with a takeaway layout conveyor 11. The slicing machine includes a housing. The housing includes a knife guard 3, a separator cover 19, a mechanical housing cover 14, a feed bed 8, a rear main support panel 10, a front main support panel 18, and a rear support panel 19. The housing is supported by a lateral support components 15. The clear polycarbonate feed bed cover 6, is slidingly, rotatably, or otherwise attached to the rest of the housing such that it may be moved between an open position and a closed position to allow the placement of food to be sliced on the feed bed 8. The separator cover 19; divides a non-food contaminated electrical and mechanical component area and a food contact feed bed area. A feed bed 8 is enclosed by the general housing when the feed bed cover is in the closed position. A gripper device 9 extends into the feed bed area and is configured to move laterally between the rear main support 10 panel and the front main support 18 panel to advance food on the feed bed 8. A control panel 7 on the outside of the housing is configured for allowing operator inputs such as start, stop, electronic touch panel and adjustment of the slice thickness using a rotary switch.

To coordinate and control the advancement of the gripper 9, and referring to FIG. 2 the speed of the knife, and/or the operation of the conveyer, the slicer machine includes a controller. The controller is an electronic, computerized control unit module adapted to regulate operations of the slicer machine. The controller includes a processor and memory components together with a touch panel control screen 24. The memory components includes a computer readable medium onto which computer code is stored. When executed by the processor, the computer code causes the gripper 9; to advance, the knife blade 25 to rotate, and/or the conveyer 11 to move to achieve desired operator results entered into the control panel. The controller includes functions, steps, routines, data tables, data maps, charts, and the like, saved in, and executable from, read only memory, or an other electronically accessible storage medium to control the slicing machine.

The operation of slicing begins when an operator identifies the food product, meat, meat product, cheese loaf or vegetable to be sliced. Referring to FIG. 1; The operator locates the clear plastic feed door safety cover 6; which is located at the front of the slicing machine. The hinged safety cover 6; is raised by the operator. The operator then places the loaf to be sliced onto the stainless steel slicing feed bed 8; in front of or in this view immediately to the left of the gripper 9. Having placed the product loaf as far back on the feed bed 8; as possible the operator then pushes the loaf against the gripper 9. The operator then closes the safety cover 6. Embodied within the safety cover 6; is a mechanical safety interlock (not visible) which upon closing the safety cover 6; allows the slicing machine to operate. A sensing mechanism or other device generates a signal when the safety interlock is engaged. The slicing machine controls prevent operation until this interlock safety signal is received. The safety interlock is now engaged and once the machine begins slicing, the plastic safety cover 6; cannot be opened.

Referring to FIG. 2; The operator, having loaded the product may now make three selections into the control panel 24. The first selection indicates the desired slice thickness 23; the second selection indicates how much of the product is to be sliced and how the completed sliced product is to be “laid out”. The third selection on the control panel 24; comprises the start 21: and stop 22: button. Although operator input devices on the control panel are described as buttons, the input devices include one or more other forms such as a touch sensitive screen, a dial, a switch, a keyboard, an audio input, or any other operator input device known in the art. The slicing machine includes the control speed of advancement of the gripper 9; along the feed bed 8; to control the thickness of the slices, and the “layout” of the slices. In one embodiment, the knife rotates at a substantially constant speed. Thus, the thickness of a slice is proportional to the speed at which the gripper 9; advances the food to be sliced by the knife 25. The advance of the gripper is paused for a period to create “layout” on the conveyer 11. The length of the pause period may be proportionate with the amount of space desired between a first set of multiple slices and a second set of multiple slices. The length of time between pause periods is proportional to the number of slices in a set. Other embodiments of controls also vary the knife rotational speed as would be understood by a person skilled in the art.

Referring to FIG. 2; After loading the slicing machine and selecting the slicing parameters, the operator now presses, start 21; located on control panel plate 20. Referring to FIG. 7; The main knife motor 33; starts ramping up to full speed and through a mechanical means of timing belt and pulley or some other arrangement, the motor drives the main knife shaft 35; to rotate, which turns or rotatably drives the main involute slicing knife 25. The main motor 33; reaches full speed in a few seconds. At this point the gripper 9; located at the rear of the food product loaf begins advancing the food product loaf forward toward the rotating involute slicing knife 25. The feed drive ball screw 32 unit assembly with enclosed drive motor 34; and controlled by means of an electronic controller now advances the food product loaf toward the involute slicing knife 25 at an exacting rate of speed. The computer programming within the controller 24; has the calculations as to exact advance speed to produce the exact slice thickness already programmed. The advancing mechanism may take many forms as will be realized by one skilled in the art. For example a ball and screw gear set or other gear set may be used. Clutches, or other mechanical transmission means may control the speed of the gripper. In some embodiments, a separate motor may power the gripper advancement than the main motor powering the rotation of the knife.

Referring to FIG. 4 As the loaf of food product is propelled to the point of the furthest edge of the shear edge 26; the slicing of the product occurs. The calculation of the speed of the rotating knife and the calculation of the speed of the advancing gripper 9; may produce the exact and consistent slice thickness of the food product.

As each slice occurs, the cut piece is propelled forward and fall downward to land onto the conveyor belt 11. The conveyor belt 11 through the instructions previously entered into the control panel 24 is advancing at the appropriate speed in order to achieve the desired “layout”. The conveyor is powered by the main motor or alternatively by another motor or power means. An electronic device controls the speed of the conveyor. If the conveyor belt 11 pauses for a period of time stacking may occur. If the conveyor has been programmed to advance a distance in synchronization with the rotating knife 25; the slices falls into an offset “shingle” pattern. Speed up the conveyor to a faster speed and the slices lay down individually.

Once the gripper 9; has reached the farthest forward advance, the main knife 25; shuts off, the feed drive 32; unit stops and then reverses in direction. When the feed drive unit reaches its original pre start or “home” position it too stops. It is at this point that the safety interlock is released, allowing the operator to open the safety cover 6, and allow loading of the next product to be sliced. At no time does an operator, other than entering selections into a touch screen, have to exert any physical or repetitive motion in order to achieve a sliced product, thus eliminating any possibility of injury.

The assembly of the slicing machine begins with the assembly of the structural frame. The main vertical members of the structural frame and referring to FIG. 1 are the front main support panel 18; and rear main support panel 10; fabricated from stainless steel plate or other suitable material these panels are connected by lateral support components 14,15, and 16. These components are mechanically secured by means of carriage bolts and/or other suitable securing devices. Together these members form a substantially rectangular frame in size or “footprint” roughly the same size as existing slicers.

Once the structural frame has been assembled, the main shaft 35; along with the front bearing housing 36; and the rear bearing housing 37; are assembled by means of bolts, nuts and washers or other suitable means and because of the use of square locating carriage bolts aligns the entire slicing machine structure.

In regard to the component structure and safety the following may apply. The structure of the slicing machine and the safety in the operation of the slicing machine are integrated through the design. The rotating involute knife 25 is perhaps the single most dangerous part of the machine. To this end, the rotating knife is completely enclosed in a stainless steel knife guard 2. This knife guard acts as a hinged door which, when the machine is completely de-energized allows access for cleaning and maintenance. The knife guard 2; may not be opened except through the releasing of safety handle 5. The handle is a round handle or other type of handle that is attached to a threaded rod. The opening of the knife guard 2; requires that the operator unscrew the safety handle 5. Should an individual attempt to unscrew the safety handle 5; in order to open the knife guard 2; while the machine is energized, a safety switch is activated disconnecting all power to the machine and enacting an electronic brake to stop the rotation of the main knife 25.

At the rear of the machine a mechanical housing cover 3; also of stainless steel (or another suitable material) construction covers the mechanical housing 3. The housing is affixed to the structural frame and is bolted and be configured to not open while the machine is operating. Across the top and front of the machine a formed stainless steel cover 14; is permanently attached to the frame. This cover separates the food slicing operator area from the mechanical area to the rear of the machine.

The lateral support member 15; with cover acts as a lower guard and it too is permanently attached in place and configured to prevent removal. The Feed bed 8; sits on top of the lateral support member 15. This feed bed, along with the shear edge 26; are parts which come in direct contact with food product. These two parts are configured to be removable without the use of tools for easy cleaning.

Although shown and described as being comprised of sheet metal, the housing may also be cast or formed of a plastic or other suitable synthetic, as would be known in the art.

Slicing machines commonly referred to as deli slicers are generally acknowledged to have been developed in the late 1800's. The design of these machines typically reveal a rotating circular knife rotated by a manually operated flywheel or more commonly an electric motor. The food product to be sliced is placed on a tray or carriage mounted on linear shafts parallel to the circular knife. This slicing machine design allow the food product moves, it is passed in a reciprocating manner past the rotating circular knife thus producing a slice.

Traditional slicing machine designs require that the carriage of food product be moved along the face of the circular knife once per slice in a repetitive reciprocating fashion.

The design is typically of one of two designs “manual machines or “automatic” machines. In the case of manual machines an operator is required to grasp a handle located on the food carriage and repeatedly push the food product past the circular knife, one slice requires one forward and one return motion.

In the case of the “automatic” slicing machine the operator is required to place the food product onto the carriage and the reciprocating forward and return motion is achieved by means of a cantilever mechanical arm.

Safety is a concern with the reciprocation motion of these machines in two ways. The first is through the repetitive motion an operator must endure in order to slice one slice. This repetitive stress syndrome is well documented in medical journals and in the food processing industry. The second danger to the movement of the steel carriage in a reciprocating back and forth motion. The weight of the carriage food product can easily be upwards of 25 pounds of steel and food, and could easily injure any passing individual.

The carriage and food product on the above designed machines are unguarded and can produce injury to passing individuals.

Either manual operation or automatic operation of traditional slicing machines is achieved in the time of approximately one slice per second. Both machines require the circular knife to be continually exposed to the operator with greater exposure occurring the thicker the desired slice.

The above referenced designs also requires that to increase the thickness of each slice a dial is turned which increases the distance between the circular plate and the cutting edge of the food. This turning of a dial causes a mechanical gear to turn a mechanical shaft to adjust slice thickness. The greater the thickness, the greater the exposure of the circular knife. The greater the slice thickness and exposure of the knife, the greater the chance of injury of the machine operator due to the increased exposure of a rotating circular knife.

The product which has been sliced on the above cited machines are typically sliced onto a tray or collecting pan. If no operator collects the sliced products then the slices fall into a pile of shaved or bulk sliced product.

If an operator stands by the machine and collects the slices then the operator may stack or attempt to “shingle” the sliced product. The resulting “stacked” or “shingled” product typically results in inconsistent “drafts” or groupings and would be suitable for wrapping and sale, but not suitable for placing into clear plastic bags and being displayed in detail cases for retail sale.

The process relative to the above machines is slow. The significance of the speed of slicing is that the above machines would consume large amounts of paid employee time in order to achieve accurate packages of shingled or stated drafts of product which may then later be vacuum packed, labeled, and displayed for retail sale. The above machines are not practical to profitably slice and package sliced food product.

In this embodiments of the invention, and referring to FIG. 6 a slicing machine includes an involute 25 style slicing knife which rotates on a shaft by means of an electric motor, a fixed tray upon which the food product to be sliced is placed, and a gripping 9; device which is placed at the rear of the product to be sliced. The gripping device is attached to a mechanical linear drive unit which is attached to a second motor and electronic controller.

The embodiment of the invention, the design of the slicing machine allows for the pushing of the food product directly through the cutting plane of the involute knife. The involute knife, which by its design creates an opening with each rotation allows for the product to pass the cutting plane but then immediately creates one slice of product with each rotation. The food product is passed through the cutting plane not parallel to the cutting plane as with the old style machine.

In the embodiment of the invention, the design of the slicing machine entirely eliminates the reciprocating motion of the old deli slicing design. Indeed, no repetitive motion per slice ever occurs with the new design.

In the embodiments of the invention, the elimination of the repetitive motion eliminates the possibility of repetitive stress injury to a machine operator or injury to any passing individual who may be struck by the food carriage which can be of considerable weight and velocity.

In some embodiments of the invention, the design of the slicing machine utilizes an electric motor/ball screw and electronic controller design to determine the slice thickness. Entering a desired slice thickness using an electronic rotary dial or human interface device instructs the “feed drive” controller and motor to push the food product to be sliced at a faster or slower rate of advance. If the food product is advanced toward the involute knife at a slower rate, a thinner slice results. If the food product is advanced at a faster rate, a thicker slice results.

In some embodiments of the invention, the control of the slice thickness by electric motor/ball screw eliminates another serious injury issue. In the typical deli slicer design, slice thickness is determined by exposing more of the circular rotating knife and creating a greater possibility of injury. The design of the new slicer referenced has no such exposure of the knife. The knife is completely enclosed in a stainless steel enclosure. This design passes food product through the rotating knife not parallel to a circular knife.

In the embodiment of the invention, the design of the new slicing machine is completely and safely enclosed within a stainless steel and for plastic enclosure which includes: a mechanical area; a chamber in which the knife rotates; a food tray area on which the food product to be sliced is placed; a “take away area which contains the attached conveyor onto which the sliced product is placed and subsequently moved away from the machine for further processing.

In the embodiment of the invention, the mechanical area which contains the moving parts: motors, ball screws, timing sheaves and belts: is completely enclosed and secured using screws and bolts.

In the embodiment of the invention, the involute knife slicing area is completely enclosed within a stainless steel hinged door. A rotary knob secures the door in the closed, operating position. If the rotary safety knob is turned a proximity sensor will cause the machine to shut off. The machine cannot operate with the knife guard door in the open position.

In the embodiment of the invention, the clear plastic door completely covers the tray onto which the food product is placed. The clear door can be opened to allow for new food product to be placed in the slicing position. However, in the open position the machine is inoperable. A proximity sensor allows the machine to operate only when this clear plastic feed door is completely closed.

In the embodiment of the invention, the new slicing machine is controlled with the use of a digital controller and small micro controller. Old design slicers typically control the slice thickness by mechanical means and are inexact by nature. The new slicing machine controls slice thickness through an electrical signal determined by a signal of a microprocessor in conjunction with a human interface device and can be controlled one thousandths of an inch.

In the embodiments of the invention, the new slicing machine maintains a consistent slice thickness while the entire product is being sliced. Slice thickness in the old slicing design can be inconsistent being greatly influenced by the amount of pressure exerted by the machine operator, by the weight of the food product remaining to be sliced or by the “flopping around” of the food product remaining on the slicing carriage. The new machine design eliminates these inconsistencies. Slicing is controlled electronically and remains consistent throughout the slicing process.

In the embodiments of the invention, the design of the new slicing machine also controls the product after the product has been sliced. The output of the old slicing machines may have some mechanical output device attached but typically output is controlled by the machine operator. If a consistent stacking or “laying out” into shingled or stacked slices is desired it is done by the operator and it is typically an inconsistent and time consuming operation.

In some embodiments of the invention, the design of the new slicing machine uses an attached conveyor belt which is positioned in the knife guard slicing area under the rotating knife and extends out the front of the machine while being securely and safely enclosed under clear plastic guards.

In some embodiments of the invention, the conveyor size is the full width of the slicing area and is controlled by the microprocessor and input through the human interface device.

In some embodiments of the invention, the software programming controlling the conveyor allows for various arrangements of sliced product, i.e. stacked slices, stagger stacked slices, shingled slices, single shingled slices as well as adjustments for spacing of the slices, arranging slices into “drafts” (or number of grouped slices), slice thickness and the slice count.

In some embodiments of the invention, the software programming also controls the speed at which the machine operates. The old slicing machines are designed to operate at approximately one slice per second. The new slicer design is designed to operate at from 1-25 slices per second depending on the product being sliced and the desired “layout” of the sliced product.

In some embodiments of the invention, the design of the new slicing machine, the accuracy, speed, and layout capability of the new machine will radically change the industry of pre sliced food product. Presently the pre sliced and packaged industry is controlled by large food processing manufacturers. The new machine is small and is designed for the end user, grocery stores, and restaurants to be able, for the first time, to economically produced sliced pre packaged food for sale in their locations.

1. An apparatus for the automatic slicing and portioning of food product; comprising a involute rotary knife; a feed bed for the food product; a gripper configured to move the food along the feed bed and into the slicing compartment, and a conveyor to accept the sliced food product and
move sliced product away from the slicing apparatus.

2. The apparatus of claim 1 wherein the food product moves toward and through the involute rotating knife in order to slice the food product.

3. The apparatus in claim 1 comprising a horizontal shaft; a vertical knife, a horizontal product feed bed and a vertical slicing chamber.

4. The apparatus in claim 1 wherein the food product once sliced falls upon an accepting conveyor to move the food product away from the slicing apparatus.

5. The apparatus in claim 1 which is controlled by an electronic controlling device that allows for the sliced products to fall onto the accepting conveyor and to be arranged into various desirable “layout” configurations.

6. The apparatus for slicing food product; comprising a mechanical housing; a product loading feed bed; a slicing chamber; a conveying area; and an electronic controls area.

7. The apparatus in claim 6 having an electronic controls area and mechanical housing compartment area being completely separate from the food contact areas of the feed bed; slicing chamber; and conveying area.

8. The apparatus in claim 7 having electronic controls which allow for the laying out of sliced food product to exact slice thickness. This also allows for the control of the number of slices desired, control of the space between the slices, and control over the overlapping or “layout” of the sliced product.

9. The electronic controls in claim 6 which maintain a electronic file in regard to the product which was sliced, the date and time the product was sliced, and maintaining an unique identification number for each portion of sliced product produced.
